(19) United States
(12) Patent Application Publication
(10) Pub. No.: US 2020/0394973 A1
(43) Pub. Date: Dec. 17, 2020

(54) METHOD OF CONTROLLING IMAGE DISPLAY DEVICE, IMAGE DISPLAY DEVICE, AND IMAGE DISPLAY SYSTEM

(71) Applicant: SEIKO EPSON CORPORATION, Tokyo (JP)

(72) Inventors: Kentaro IDE, Shiojiri-shi (JP); Yasuhiro HONDA, Shiojiri-shi (JP); Shingo YOSHIDA, Matsumoto-shi (JP)

(73) Assignee: SEIKO EPSON CORPORATION, Tokyo (JP)

(21) Appl. No.: 16/898,217

(22) Filed: Jun. 10, 2020

(30) Foreign Application Priority Data
Jun. 11, 2019 (JP) 2019-108502

(51) Int. Cl. G09G 3/34; G03B 21/20

(52) U.S. Cl. CPC G09G 3/3406; G09G 2320/068; G03B 21/2013

(57) ABSTRACT

In a method of controlling a projector for displaying a whole image having partial images arranged based on image information supplied from an image supply device in cooperation with a projector, there are included the steps of displaying the partial image based on a part of the image information supplied from the image supply device, outputting the image information to the projector for displaying the partial image based on another part of the image information, obtaining configuration information related to the arrangement of the partial images, deciding overall resolution as the resolution for displaying the whole image based on the configuration information obtained, and storing the overall resolution to a resolution storage section for storing the resolution to be given to the image supply device as a notice.

The present application is based on, and claims priority from JP Application Serial Number 2019-108502, filed Jun. 11, 2019, the disclosure of which is hereby incorporated by reference herein in its entirety.

### BACKGROUND

### 1. Technical Field

The present disclosure relates to a method of controlling an image display device, an image display device, and an image display system.

### 2. Related Art

There has been known a system for displaying a single large image using a plurality of image display devices. A system described in JP-A-2013-80229 includes a plurality of units as an image display device, and an input module, and a video source for supplying the system with a video signal is coupled to each of the units via the input module. The video source recognizes the system as a single image display device, and obtains the information such as the resolution of the system with EDID (Extended Display Identification Data) set in the system. In the system described in Document 1, the user is made capable of changing the EDID in accordance with the arrangement of the units.

However, in the system described in Document 1, it is necessary for the user to derive the resolution of the system constituted by the plurality of units by him- or herself, and further set the resolution as the EDID. In other words, the user must perform a cumbersome operation in order to display the image with appropriate resolution.

### SUMMARY

A method of controlling an image display device is a method of controlling an image display device configured to display a whole image having a first image and a second image arranged based on image information supplied from an image supply device in cooperation with another image display device. The method includes obtaining configuration information related to an arrangement of the first image to be displayed by the image display device and the second image to be displayed by the other image display device, deciding overall resolution as resolution for displaying the whole image based on the configuration information obtained to store the overall resolution to a resolution storage section, notifying the image supply device with the overall resolution stored in the resolution storage section, obtaining the image information from the image supply device notified with the overall resolution, displaying the first image based on a part of the image information, and outputting the image information to the other image display device configured to display the second image based on another part of the image information.

In the method of controlling the image display device described above, a highest resolution value with which the image display device and the other image display device can perform display may be calculated based on the configuration information to decide the resolution value as the overall resolution.

In the method of controlling the image display device described above, the image display device may store a resolution list including a plurality of resolution values, a tentative resolution value as a highest resolution value with which the image display device and the other image display device can perform display may be calculated based on the configuration information, and a resolution value no higher than the tentative resolution value may be extracted from the plurality of resolution values included in the resolution list to decide the extracted resolution value as the overall resolution.

In the method of controlling the image display device described above, highest one of resolution values no higher than the tentative resolution value may be extracted from the plurality of resolution values included in the resolution list to decide the extracted resolution value as the overall resolution.

In the method of controlling the image display device described above, the image display device may be a projector, the first image and the second image may be arranged so as to partially overlap each other, and the configuration information may include information representing a width of an overlapping area where the first image and the second image overlap each other.

The image display device is an image display device configured to display a whole image having a first image and a second image arranged based on image information supplied from an image supply device in cooperation with another image display device, including an acquisition section configured to obtain configuration information related to an arrangement of the first image to be displayed by the image display device and the second image to be displayed by the other image display device, a decision section configured to decide overall resolution as resolution for displaying the whole image based on the configuration information obtained by the acquisition section, a resolution storage section configured to store the overall resolution decided by the decision section, a notification section configured to notify the image supply device with the overall resolution stored in the resolution storage section, an input section to which the image information is input from the image supply device notified with the overall resolution, a display section configured to display the first image based on a part of the image information, and an output section configured to output the image information to the other image display device configured to display the second image based on another part of the image information.

The image display system includes a first image display device configured to display a first image based on apart of image information supplied from an image supply device, and a second image display device configured to display a second image based on another part of the image information, wherein a whole image having the first image and the second image arranged is displayed, and the first image display device includes an acquisition section configured to obtain configuration information related to the arrangement of the first image and the second image, a decision section configured to decide overall resolution as resolution for displaying the whole image based on the configuration information obtained by the acquisition section, a resolution storage section configured to store the overall resolution decided by the decision section, a notification section configured to notify the image supply device with the overall resolution stored in the resolution storage section, an input section to which the image information is input from the image supply device notified with the overall resolution, a display section configured to display the first image based on the image information input to the input section, and an output section configured to output the image information input to the input section to the second image display device.

### BRIEF DESCRIPTION OF THE DRAWINGS

FIG. 1 is a configuration diagram showing an image display system.

FIG. 2 is a block diagram showing a schematic configuration of a projector.

FIG. 3 is a block diagram showing a schematic configuration of an image projection section.

FIG. 4 is an explanatory diagram showing connection of the projector.

FIG. 5 is a flowchart showing an operation of the projector when executing the setting process related to multi-projection.

FIG. 6 is a flowchart showing an operation of a master projector which has completed the setting process related to the multi-projection.

FIG. 7 is an explanatory diagram showing the connection when using three or more projectors.

### DESCRIPTION OF AN EXEMPLARY EMBODIMENT

An image display system according to the present embodiment will hereinafter be described with reference to the drawings.

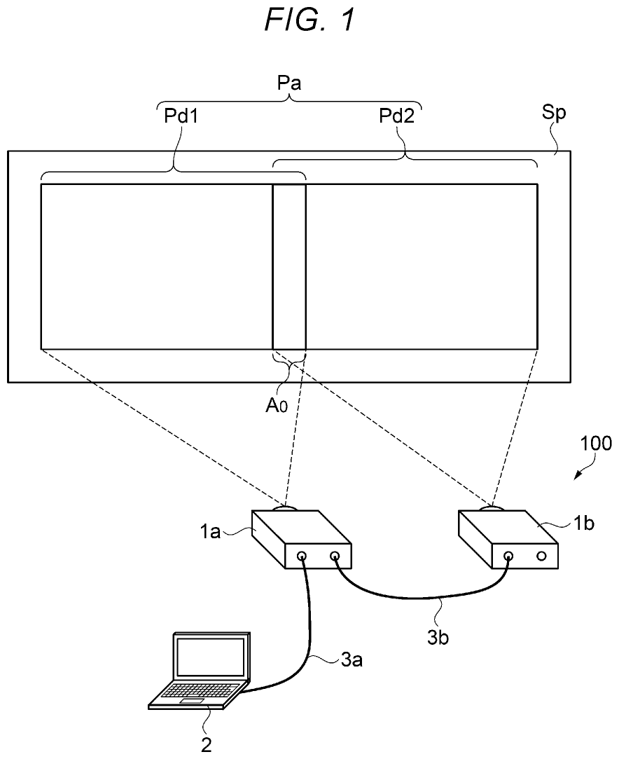

FIG. 1 is an explanatory diagram showing the image display system 100 according to the present embodiment.

As shown in FIG. 1, the image display system 100 is provided with two projectors 1a, 1b as image display devices. The projectors 1a, 1b respectively project to display images Pd1, Pd2 on a projection surface Sp such as a screen or a wall surface. The projectors 1a, 1b are installed so that the images Pd1, Pd2 respectively projected therefrom are arranged side by side. In other words, the multi-projection in which a plurality of projectors 1a, 1b cooperates with each other to display a single large image Pa is realized by the image display system 100. Hereinafter, the images Pd1, Pd2 respectively projected from the projectors 1a, 1b are each referred to as a “partial image,” and the single large image Pa including these images is referred to as a “whole image.” Further, when describing the two projectors 1a, 1b without distinguishing them from each other, both are also described as “projectors 1,” and when describing the two partial images Pd1, Pd2 without distinguishing them from each other, both are also described as “partial images Pd.”

In the example shown in FIG. 1, the projectors 1a, 1b are installed so that the two partial images Pd1, Pd2 are arranged in a lateral line, and further, partially overlap each other. Therefore, it is made possible to smoothly join the partial images Pd1, Pd2 without forming a space between the partial images Pd1, Pd2. An area Ao where the partial images Pd overlap each other is hereinafter also referred to as an “overlapping area Ao.” The luminance in the overlapping area Ao is held lower than in other areas in each of the partial images Pd so as to prevent the overlapping area Ao where a plurality of partial images Pd overlaps from becoming higher in luminance than other areas.

One 1a of the projectors is coupled to an image supply device 2 located outside and formed of a computer, a video reproduction device, or the like via a cable 3a. Further, the projector 1a is coupled to the other 1b of the projectors via a cable 3b. In other words, the plurality of projectors 1a, 1b is coupled to the image supply device 2 with daisy chain connection. The projector 1a is supplied with image information from the image supply device 2 via the cable 3a, and then supplies the image information thus supplied to the projector 1b via the cable 3b. The projector 1a displays the partial image Pd1 based on a part of the image information supplied from the image supply device 2, and the projector 1b displays the partial image Pd2 based on another part of the image information. Hereinafter, the projector 1a coupled to the image supply device 2 is also referred to as a “master projector,” and the projector 1b as the rest of the projectors is also referred to as a “slave projector.” The projector 1a corresponds to a first image display device, and the projector 1b corresponds to a second image display device and another image display device. Further, the partial image Pd1 displayed by the projector 1a corresponds to a first image, and the partial image Pd2 displayed by the projector 1b corresponds to a second image.

It should be noted that the number of the projectors 1 constituting the multi-projection is not limited to two, but can also be three or more. Further, the arrangement of the partial images Pd is not limited to the lateral line, but can also be a vertical line or a matrix arrangement having a plurality of lines in vertical and lateral directions.

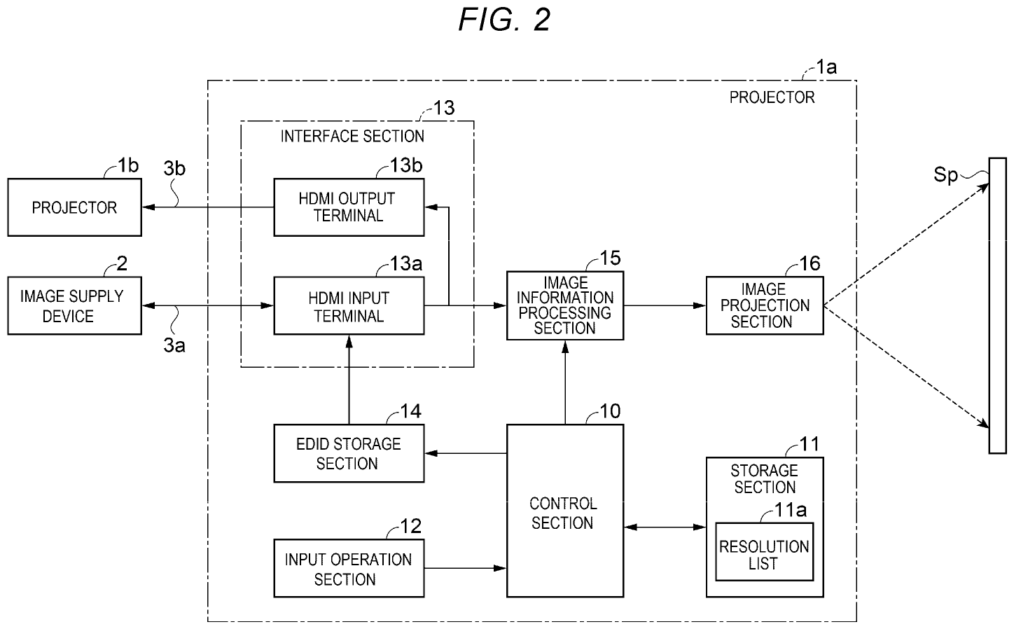

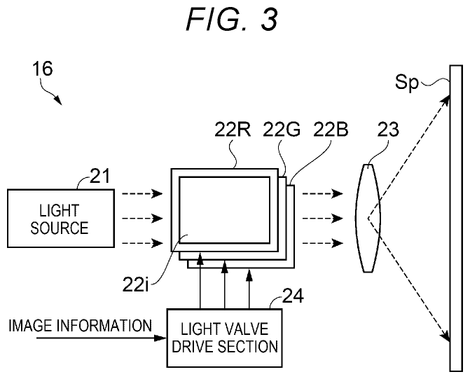

FIG. 2 is a block diagram showing a schematic configuration of the projector 1a, and FIG. 3 is a block diagram showing a schematic configuration of an image projection section 16 provided to the projector 1a.

As shown in FIG. 2, the projector 1a is integrally provided with a control section 10 as a decision section, a storage section 11, an input operation section 12, an interface section 13, an EDID storage section 14 as a resolution storage section, an image information processing section 15, and an image projection section 16 as a display section. The projector 1a projects the partial image Pd1 from the image projection section 16 on the projection surface Sp based on the part of the image information input to the interface section 13.

The control section 10 is configured including one processor or a plurality of processors, and operates along a control program stored in the storage section 11 to thereby integrally control the operation of the projector 1a.

The storage section 11 is configured including memory devices such as a RAM (Random Access Memory) and a ROM (Read Only Memory). The RAM is used for temporary storage of a variety of types of data, and the ROM stores the control program, control data, and so on for controlling the operation of the projector 1a.

The input operation section 12 is provided with a plurality of operation keys not shown for the user to make a variety of instructions to the projector 1a. As the operation keys provided to the input operation section 12, there are cited a power key for switching between ON and OFF of the power, a menu key for displaying a menu image for performing a variety of types of setting, directional keys for selecting items on the menu image, a decision key for deciding the item thus selected, and so on. When the user operates a variety of operation keys in the input operation section 12, the input operation section 12 outputs an operation signal corresponding to the operation content by the user to the control section 10. It should be noted that it is also possible to adopt a configuration of using a remote controller not shown capable of a remote operation as the input operation section 12. In this case, the remote controller transmits an operation signal of an infrared ray corresponding to the operation content by the user, and then a remote control signal receiving section not shown provided to the projector 1a receives the operation signal to transmit the operation signal to the control section 10.

The interface section 13 is configured including a plurality of connection terminals, an interface circuit, and so on. The interface section 13 in the present embodiment is compatible with input and output of the image information compliant with HDMI (High Definition Multimedia Interface; registered trademark), and is provided with an HDMI input terminal 13a and an HDMI output terminal 13b as connection terminals. The HDMI input terminal 13a corresponds to an input section, and the HDMI output terminal 13b corresponds to an output section. To the HDMI input terminal 13a, there is coupled the image supply device 2 located outside via the cable 3a, and the image information is input to the HDMI input terminal 13a from the image supply device 2. The image information thus input is converted into image information with a format which can be processed by the image information processing section 15, and is then output to the image information processing section 15. To the HDMI output terminal 13b, there is coupled the other 1b of the projectors via the cable 3b, and the image information input to the HDMI input terminal 13a is directly output from the HDMI output terminal 13b to the projector 1b.

The EDID storage section 14 is formed of the RAM or the ROM, and stores the EDID (Extended Display Identification Data) of the projector 1a. The EDID includes the information such as the resolution supported by the projector 1a, and is given to the image supply device 2 as a notice from the HDMI input terminal 13a also functioning as a notification section in response to a request from the image supply device 2. In other words, the EDID includes the information such as the resolution to be given to the image supply device 2 as a notice. By obtaining the EDID from the EDID storage section 14, it becomes possible for the image supply device 2 to supply the image information with the resolution suitable for the projector 1a. The EDID includes a plurality of resolution values assigned with priority orders, and it is possible for the control section 10 to change the resolution value stored in the EDID.

The image information processing section 15 is configured including a frame memory not shown. The image information processing section 15 stores the image information input from the interface section 13 into the frame memory, and at the same time, performs a variety of processes on the image information on the frame memory based on the control by the control section 10, and then outputs the image information on which the processes have been performed to the image projection section 16. For example, the image information processing section 15 executes a process of adjusting the image quality such as luminance or contrast, a process of correcting a distortion of the image, a process of superimposing an OSD (on-screen display) image such as a menu image or a message image on the image based on the image information, and so on.

It should be noted that the image information processing section 15 can be constituted by a single processor, a plurality of processors, or the like, or can also be constituted by a dedicated processing device such as an ASIC (Application Specific Integrated Circuit) or an FPGA (Field Programmable Gate Array).

As shown in FIG. 3, the image projection section 16 is configured including a light source 21, three liquid crystal light valves 22R, 22G, and 22B as light modulation devices, a projection optical system 23, a light valve drive section 24, and so on. The image projection section 16 modulates the light emitted from the light source 21 with the liquid crystal light valves 22R, 22G, and 22B to thereby form image light, and then projects the image light from the projection optical system 23 including a lens and so on to thereby display the image on the projection surface Sp.

The light source 21 is configured including a discharge type light source lamp such as a super high-pressure mercury lamp or a metal halide lamp, or a solid-state light source such as a light emitting diode or a semiconductor laser. The light emitted from the light source 21 is converted into the light having a substantially uniform intensity distribution by an integrator optical system not shown, and is then separated into colored light components of red, green, and blue as the three primary colors of light by a color separation optical system not shown, and then the colored light components respectively enter the liquid crystal light valves 22R, 22G, and 22B.

The liquid crystal light valves 22R, 22G, and 22B are each formed of a transmissive liquid crystal panel having a liquid crystal material encapsulated between a pair of transparent substrates, polarization plates, and so on. The liquid crystal panels are each provided with a pixel area 22i having a rectangular shape and constituted by a plurality of pixels arranged in a matrix, and are each arranged so that a drive voltage can be applied to the liquid crystal material pixel by pixel.

The light valve drive section 24 forms an image in the pixel area 22i of each of the liquid crystal light valves 22R, 22G and 22B. Specifically, the light valve drive section 24 applies the drive voltages corresponding to the image information input from the image information processing section 15 to the respective pixels in the pixel areas 22i to thereby set the pixels to respective light transmission rates corresponding to the image information. The light emitted from the light source 21 is transmitted through the pixel area 22i of each of the liquid crystal light valves 22R, 22G and 22B to thereby be modulated pixel by pixel, and thus the image light corresponding to the image information is formed for each of the colored light beams. The colored light beams as the image light of the respective colors thus formed are combined with each other pixel by pixel by a color combining optical system not shown to turn to the image light representing a color image, and the image light is then projected on the projection surface Sp by the projection optical system 23 in an enlarged manner.

In the projector 1a according to the present embodiment, in the pixel area 22i in each of the liquid crystal light valves 22R, 22G, and 22B, there are arranged 1920 pixels in the lateral direction and 1080 pixels in the vertical direction. In the present embodiment, the number of the pixels in the pixel area 22i is also referred to as the “resolution,” and is described as “1920×1080” using the number of pixels in the lateral direction and the number of pixels in the vertical direction. Therefore, in the EDID in the initial state, namely in the EDID when using the projector 1a alone without performing the multi-projection, there is stored the resolution of 1920×1080 as the resolution with the highest priority order. It should be noted that the resolution of the projector 1a is not limited to 1920×1080, but can take other resolution values.

Going back to FIG. 2, the storage section 11 stores a resolution list 11a. In the resolution list 11a, there is stored a list of the resolution values which can be used when performing the multi-projection using the projector 1a. In other words, in the resolution list 11a, there are stored resolution values which can be realized by a plurality of projectors 1, in other words, the resolution values higher than 1920×1080 as the resolution of the projector 1a as a simple body. For example, in the resolution list 11a, there is included the resolution value of 3240×1080 which can be realized when arranging the partial images Pd in the lateral direction in the partially overlapped state with the two projectors 1 each having the resolution of 1920×1080. Besides the above, in the resolution list 11a, there are included a resolution value which can be realized when arranging three or more partial images Pd in the lateral direction, a resolution value which can be realized when vertically arranging a plurality of partial images Pd, further, a resolution value which can be realized when arranging a plurality of partial images Pd in a matrix, and so on.

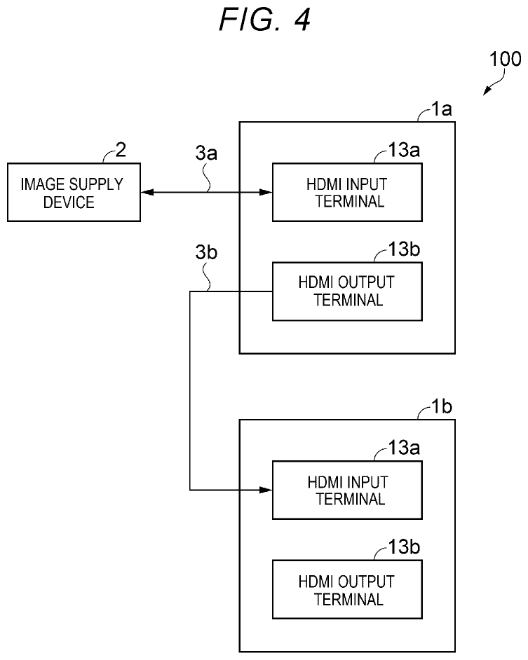

FIG. 4 is an explanatory diagram showing connection of the projectors 1a, 1b.

The configuration of the projector 1b as a slave projector is substantially the same as that of the projector 1a, and therefore, the detailed illustration will be omitted. In the following description, as the reference symbols of the constituents of the projector 1b, there are used the same reference symbols as those of the constituents of the projector 1a. In the projector 1b, the HDMI input terminal 13a is coupled to the HDMI output terminal 13b of the projector 1a via the cable 3b, and the image information is input from the projector 1a to the HDMI input terminal 13a. To the HDMI output terminal 13b of the projector 1b, there is connected nothing. In other words, unlike the projector 1a, the projector 1b does not output the image information from the HDMI output terminal 13b.

Then, an operation of the projector 1, namely a method of controlling the projector 1, will be described.

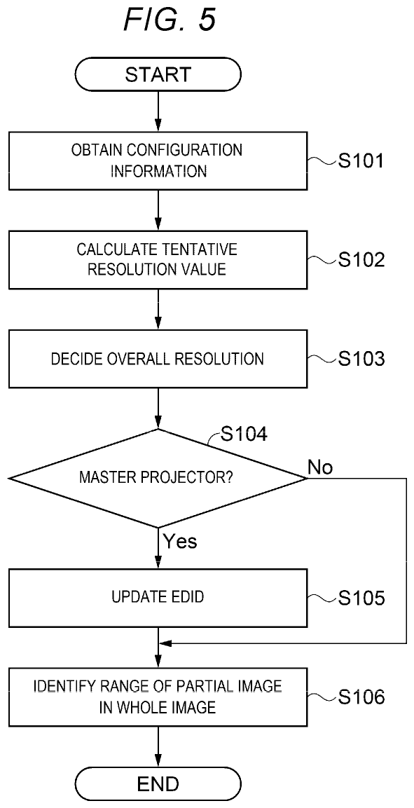

FIG. 5 is a flowchart showing an operation of the projector 1 when executing a setting process related to the multi-projection.

When executing the multi-projection with the image display system 100 according to the present embodiment, it is necessary for the user to perform setting related to the multi-projection to each of the projectors 1 after performing the installation of the projectors 1. When the user operates the menu key in the input operation section 12 to display the menu image not shown, and then selects an item for performing the setting of the multi-projection from the menu image, the control section 10 of the projector 1 operates along the flow shown in FIG. 5.

As shown in FIG. 5, in the step S101, the control section 10 obtains configuration information related to the multi-projection. Specifically, the control section 10 instructs the image information processing section 15 to display the setting screen not shown as an OSD image to allow the user to input the configuration information related to the multi-projection. On this setting screen, it is possible for the user to input the information representing whether or not the projector 1 as the setting target is the master projector, the number of the projectors 1 used in the multi-projection, the information related to the arrangement of the partial images Pd, and so on. Further, when the projector 1 as the setting target is the slave projector, the user designates a relative positional relationship between the partial image Pd of the projector 1 and the partial image Pd of the master projector, and so on. The user operates the direction keys and the decision key in the input operation section 12 to input such configuration information. It should be noted that as the information related to the arrangement of the partial images Pd, there are included, for example, a layout of the partial images Pd which can be designated by the number of vertical lines and the number of lateral lines, and information representing the width of the overlapping area Ao. Here, the width of the overlapping area Ao is assumed to be represented by the number of pixels, it is also possible to adopt an aspect of designating the width as the proportion to the whole width of the partial image Pd. The control section 10 when obtaining the configuration information in the step S101 corresponds to an acquisition section.

In the step S102, the control section 10 calculates a resolution value which can be used in the multi-projection, in other words, a tentative resolution value as the highest resolution value which can be obtained with the plurality of projectors 1, based on the resolution of the projector 1 and the configuration information thus input. The tentative resolution value corresponds to the number of pixels which can be used for the display of the whole image Pa out of the total number of the pixels of the plurality of projectors 1 for performing the multi-projection, and is expressed by the number of pixels in the lateral direction and the number of pixels in the vertical direction.

For example, when projecting the two partial images Pd arranged in the lateral direction as shown in FIG. 1, the tentative resolution value is expressed by a value obtained by subtracting the number of pixels corresponding to the width in the lateral direction of the overlapping area Ao from a value twice as large as the number of pixels in the lateral direction of the pixel area 22i, and the number of pixels in the vertical direction of the pixel area 22i. Further, when projecting the two partial images Pd arranged in the vertical direction, the tentative resolution value is expressed by the number of pixels in the lateral direction of the pixel area 22i, and a value obtained by subtracting the number of pixels corresponding to the width in the vertical direction of the overlapping area Ao from a value twice as large as the number of pixels in the vertical direction of the pixel area 22i. Further, when projecting the three or more partial images Pd arranged in a line in the vertical direction or the lateral direction, since a plurality of overlapping areas Ao exists, it is sufficient to subtract the sum of the widths of the plurality of overlapping areas Ao from the total number of pixels in the vertical direction or the lateral direction. Further, when the partial images Pd are arranged in a matrix having a plurality of lines in each of the vertical and lateral directions, it is sufficient to subtract the sum of the overlapping areas Ao from the total number of pixels in both of the vertical direction and the lateral direction.

In the step S103, the control section 10 extracts one of the resolution values no higher than the tentative resolution value out of the resolution values included in the resolution list 11a in the storage section 11 based on the tentative resolution value calculated in the step S102, and then decides the resolution value thus extracted as overall resolution which is the resolution value for displaying the whole image Pa. Specifically, the control section 10 selects the resolution values no higher than the tentative resolution value in both of the vertical and lateral directions from the resolution values included in the resolution list 11a, and further extracts the highest resolution value from the resolution values thus selected.

For example, when arranging the two partial images Pd having the resolution of 1920×1080 in the lateral direction as shown in FIG. 1 to perform the multi-projection, it is assumed that the width of the overlapping area Ao is 240 pixels, namely 12.5% of the partial image Pd is used as the overlapping area Ao. In this case, when the configuration information is input by the user in the step S101, the control section 10 obtains 3600×1080 as the tentative resolution value in the step S102 since 1920×2−240=3600 is obtained. Then, in the step S103, the control section 10 extracts the resolution value of 3240×1080 as the highest one of the resolution values no higher than the tentative resolution value thus calculated from the resolution list 11a.

In the step S104, the control section 10 determines whether or not the own projector is the master projector based on the configuration information input in the step S101. Then, the control section 10 makes the transition of the process to the step S105 when the own projector is the master projector, or makes the transition of the process to the step S106 when the own projector is the slave projector.

When the own projector is the master projector, and the transition of the process to the step S105 has been made, the control section 10 updates the EDID stored in the EDID storage section 14. Specifically, the control section 10 stores the overall resolution decided in the step S103 in the EDID as the resolution value with the highest priority order, and then stores the EDID in the EDID storage section 14.

In the step S106, the control section 10 identifies the range of the own partial image Pd in the whole image Pa having the overall resolution based on the configuration information input in the step S101 and the overall resolution decided in the step S103. The control section 10 stores the range thus identified in the storage section 11, and then terminates the flow. The flow described hereinabove is executed by all of the projectors 1 constituting the multi-projection.

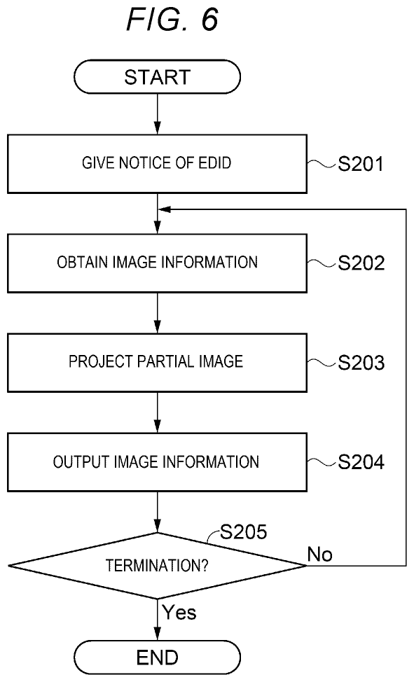

FIG. 6 is a flowchart showing an operation of the master projector which has completed the setting process related to the multi-projection.

As shown in FIG. 6, the projector 1a as the master projector notifies (step S201) the image supply device 2 of the EDID thus updated in response to the request from the image supply device 2. The image supply device 2 obtains the EDID to recognize the overall resolution as the resolution value with the highest priority, and thereafter starts to supply the image information with the overall resolution. The projector 1a obtains (step S202) the image information supplied from the image supply device 2. Then, the projector 1a extracts a part of the image information, namely the image information in a range handled by the projector 1a, out of the image information with the image information processing section 15, and then projects (step S203) the partial image Pd1 based on the image information thus extracted from the image projection section 16.

Further, the projector 1a outputs (step S204) the image information supplied from the image supply device 2 directly to the projector 1b as the slave projector. Similarly, the projector 1b also extracts another part of the image information, namely the image information in a range handled by the projector 1b, out of the image information supplied from the projector 1a with the image information processing section 15, and then projects the partial image Pd2 based on the image information thus extracted from the image projection section 16. The projector 1a determines (step S205) whether or not the input operation of instructing the termination of the projection of the image has been made by the user, and when the instruction of the termination has not been made, the projector 1a repeats the acquisition of the image information (step S202), the projection of the partial image Pd1 (step S203) and the output of the image information (step S204) until the instruction is made. In contrast, when the instruction of the termination has been made, the projector 1a terminates the flow described above. According to the operation described above, the plurality of partial images Pd1, Pd2 is arranged on the projection surface Sp to be displayed as the single whole image Pa.

It should be noted that although not shown in the drawings, the control section 10 of the projector 1a as the master projector executes a process of restoring the EDID to the EDID in the initial state, namely the EDID when using the projector 1a as a simple body when the termination of the multi-projection has been instructed by the user, or when the setting of releasing the master projector has been done on the setting screen.

As described hereinabove, according to the image display system 100, the projector 1, and the method of controlling these related to the present embodiment, the following advantages can be obtained.

(1) According to the present embodiment, since the projector 1a as the master projector decides the overall resolution for displaying the whole image Pa based on the configuration information related to the arrangement of the partial images Pd1, Pd2, it becomes unnecessary for the user to derive the overall resolution by him- or herself, and it becomes easy to display the whole image Pa with the appropriate resolution.

(2) According to the present embodiment, since the highest one of the resolution values no higher than the tentative resolution value calculated is extracted from the resolution values included in the resolution list 11a to be decided as the overall resolution, it becomes possible to display the whole image Pa as large as possible with the appropriate resolution which can be assumed in advance.

(3) According to the present embodiment, the plurality of projectors 1 is coupled to the image supply device 2 with the daisy chain, and the overall resolution is given to the image supply device 2 as a notice by changing the EDID of the master projector. Therefore, it becomes unnecessary to make a special device intervene between the image supply device 2 and the plurality of projector 1, and thus, it becomes possible to simplify the configuration of the image display system 100.

(4) According to the present embodiment, it is sufficient for the image supply device 2 to execute a usual operation of obtaining the EDID of the projector 1 coupled to the image supply device 2 and then transmitting the image information with the resolution corresponding to the EDID thus obtained to the projector 1. Therefore, it is unnecessary to add a special function to the image supply device 2, and it becomes easy to display the whole image Pa with the appropriate resolution.

Further, the embodiment described above can also be modified as follows.

Although in the embodiment described above, there is described the aspect of performing the multi-projection with the two projectors 1a, 1b, the number of the projectors 1 constituting the multi-projection is not limited to two, but can also be three or more. When constituting the image display system 100 using the three or more projectors 1, one master projector and a plurality of slave projectors are coupled to the image supply device 2 with the daisy chain.

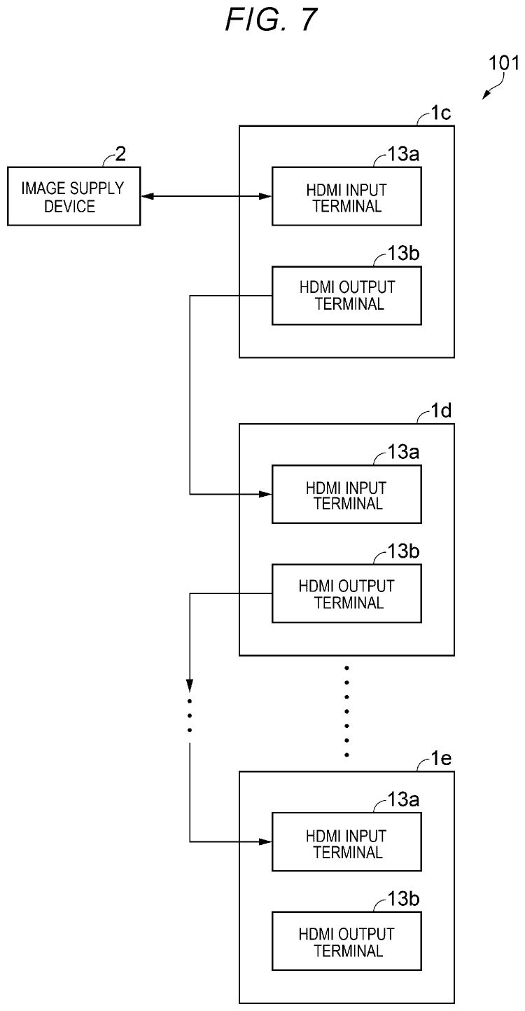

FIG. 7 is an explanatory diagram showing the connection when using three or more projectors.

As shown in FIG. 7, the image display system 101 includes at least three projectors 1c, 1d, and 1e. Among these, the projector 1c is the master projector, and the rest of the projectors, namely the projectors 1d, 1c, are the slave projectors. Similarly to the projector 1a described above, the projector 1c as the master projector has the HDMI input terminal 13a coupled to the image supply device 2, and the HDMI output terminal 13b coupled to the HDMI input terminal 13a of the projector 1d located downstream. The projector 1e as the terminal slave projector located downstream has the HDMI input terminal 13a coupled to the HDMI output terminal 13b of the projector 1 located upstream, and has the HDMI output terminal 13b to which nothing is coupled similarly to the projector 1b described above. Further, the slave projector such as the projector 1d coupled between the master projector and the terminal slave projector has the HDMI input terminal 13a coupled to the HDMI output terminal 13b of the projector 1 located upstream, and has the HDMI output terminal 13b is coupled to the HDMI input terminal 13a of the projector 1 located downstream. According also to such a configuration, substantially the same advantages as in the embodiment described above can be obtained.

Although in the embodiment described above, there is described the aspect in which the plurality of projectors 1a, 1b has the same resolution, it is also possible to perform the multi-projection with a plurality of projectors 1 different in resolution. In this case, for example, by making the resolution of each of the projectors 1 be inputted in the setting screen for performing the setting related to the multi-projection, it is possible to appropriately calculate the tentative resolution value.

Although in the embodiment described above, there is described the aspect in which the user inputs the configuration information related to the multi-projection to all of the projectors 1, it is also possible to arrange to, for example, provide a device for sharing the configuration information input to the master projector by all of the projectors 1. For example, by arranging to provide the projectors 1 with a communication section for performing the communication via the communication channel such as a network, it is possible to share the configuration information with the communication by the communication sections. According to this configuration, it becomes possible to simplify the input work of the configuration information by the user. Further, as described above, when the projectors 1 are different in resolution from each other, it becomes possible to obtain the resolution of each of the projectors 1 via the communication section.

In the embodiment described above, after calculating the tentative resolution value, the resolution values no higher than the tentative resolution value in both of the vertical direction and the lateral direction are selected from the resolution values included in the resolution list 11a, and then the highest resolution value is further extracted from the resolution values thus selected to thereby be decided as the overall resolution. However, this aspect is not a limitation. For example, it is also possible to extract another resolution value than the highest resolution value from the resolution values no higher than the tentative resolution value to thereby be set as the overall resolution. Further, it is also possible to arrange to directly store the tentative resolution value thus calculated to the EDID as the overall resolution.

Although in the embodiment described above, there is described an aspect in which the plurality of partial images Pd are arranged so as to partially overlap each other, the plurality of partial images Pd is not required to overlap each other, and can also be arranged so as to have contact each other, or it is possible to adopt an aspect in which the partial images Pd are arranged separately from each other. It should be noted that when arranging the partial images Pd separately from each other, the partial images Pd separated from each other constitute the whole image Pa instead of a single large image.

Although in the embodiment described above, the transmissive liquid crystal light valves 22R, 22G, and 22B are used as the light modulation devices, it is also possible to use reflective light modulation devices such as reflective liquid crystal light valves. Further, it is also possible to use a digital mirror device or the like for modulating the light emitted from the light source 21 by controlling the emission direction of the incident light for every micromirror as a pixel. Further, the configuration of providing the plurality of light modulation devices for the respective colored light beams is not a limitation, but it is also possible to adopt a configuration of modulating the plurality of colored light beams with a single light modulation device in a time-sharing manner.

In the embodiment described above, when the interface section 13 of the master projector is provided with an HDBaseT (registered trademark) terminal as the connection terminal, it is also possible to adopt an aspect in which the image information from the image supply device 2 is input to the HDBaseT terminal instead of the HDMI input terminal 13a. Further, the image information supplied from the image supply device 2 is not limited to the image information compliant with HDMI, but it is also possible to adopt an aspect in which the image information in another format is supplied to an appropriate connection terminal.

Although in the embodiment described above, the projector 1 is described as an example of the image display device, the image display device is not limited to the projection type image display device, but can also be a direct-view type image display device such as a liquid crystal display or an organic EL display. In these configurations, a display screen or the like on which the image is displayed corresponds to the display section.

Hereinafter, the contents derived from the embodiment will be described.

The method of controlling an image display device is a method of controlling an image display device configured to display a whole image having a first image and a second image arranged based on image information supplied from an image supply device in cooperation with another image display device, including the steps of obtaining configuration information related to an arrangement of the first image to be displayed by the image display device and the second image to be displayed by the other image display device, deciding overall resolution as resolution for displaying the whole image based on the configuration information obtained to store the overall resolution to a resolution storage section, notifying the image supply device with the overall resolution stored in the resolution storage section, obtaining the image information from the image supply device notified with the overall resolution, displaying the first image based on a part of the image information, and outputting the image information to the other image display device configured to display the second image based on another part of the image information.

According to this configuration, since the image display device decides the overall resolution for displaying the whole image based on the configuration information related to the arrangement of the first image and the second image, it becomes unnecessary for the user to derive the overall resolution by him- or herself, and it becomes easy to display the whole image with the appropriate resolution.

In the method of controlling the image display device described above, a highest resolution value with which the image display device and the other image display device can perform display may be calculated based on the configuration information to decide the resolution value as the overall resolution.

According to this configuration, since the highest resolution value with which the plurality of image display device can perform the display is decided as the overall resolution, it becomes possible to display the whole image as large as possible.

In the method of controlling the image display device described above, the image display device may store a resolution list including a plurality of resolution values, a tentative resolution value as a highest resolution value with which the image display device and the other image display device can perform display may be calculated based on the configuration information, and a resolution value no higher than the tentative resolution value may be extracted from the plurality of resolution values included in the resolution list to decide the extracted resolution value as the overall resolution.

According to this configuration, since the resolution value no higher than the tentative resolution value calculated is extracted from the resolution values included in the resolution list to be decided as the overall resolution, it becomes possible to display the whole image with the appropriate resolution which can be assumed in advance.

In the method of controlling the image display device described above, highest one of resolution values no higher than the tentative resolution value may be extracted from the plurality of resolution values included in the resolution list to decide the extracted resolution value as the overall resolution.

According to this configuration, since highest one of the resolution values no higher than the tentative resolution value calculated is extracted from the resolution values included in the resolution list to be decided as the overall resolution, it becomes possible to display the whole image as large as possible with the appropriate resolution which can be assumed in advance.

In the method of controlling the image display device described above, the image display device may be a projector, the first image and the second image may be arranged so as to partially overlap each other, and the configuration information may include information representing a width of an overlapping area where the first image and the second image overlap each other.

According to this configuration, even when the first image and the second image projected by the projectors are arranged so as to overlap each other, it becomes possible to appropriately decide the overall resolution based on the information representing the width of the overlapping area.

The image display device is an image display device configured to display a whole image having a first image and a second image arranged based on image information supplied from an image supply device in cooperation with another image display device, including an acquisition section configured to obtain configuration information related to an arrangement of the first image to be displayed by the image display device and the second image to be displayed by the other image display device, a decision section configured to decide overall resolution as resolution for displaying the whole image based on the configuration information obtained by the acquisition section, a resolution storage section configured to store the overall resolution decided by the decision section, a notification section configured to notify the image supply device with the overall resolution stored in the resolution storage section, an input section to which the image information is input from the image supply device notified with the overall resolution, a display section configured to display the first image based on a part of the image information, and an output section configured to output the image information to the other image display device configured to display the second image based on another part of the image information.

According to this configuration, since the image display device decides the overall resolution for displaying the whole image based on the configuration information related to the arrangement of the first image and the second image, it becomes unnecessary for the user to derive the overall resolution by him- or herself, and it becomes easy to display the whole image with the appropriate resolution.

An image display system includes a first image display device configured to display a first image based on apart of image information supplied from an image supply device, and a second image display device configured to display a second image based on another part of the image information, wherein a whole image having the first image and the second image arranged is displayed, and the first image display device includes an acquisition section configured to obtain configuration information related to the arrangement of the first image and the second image, a decision section configured to decide overall resolution as resolution for displaying the whole image based on the configuration information obtained by the acquisition section, a resolution storage section configured to store the overall resolution decided by the decision section, a notification section configured to notify the image supply device with the overall resolution stored in the resolution storage section, an input section to which the image information is input from the image supply device notified with the overall resolution, a display section configured to display the first image based on the image information input to the input section, and an output section configured to output the image information input to the input section to the second image display device.

According to this configuration, since the first image display device decides the overall resolution for displaying the whole image based on the configuration information related to the arrangement of the first image and the second image, it becomes unnecessary for the user to derive the overall resolution by him- or herself, and it becomes easy to display the whole image with the appropriate resolution.

What is claimed is:

1. A method of controlling an image display device configured to display a whole image having a first image and a second image arranged based on image information supplied from an image supply device in cooperation with another image display device, the method comprising:
obtaining configuration information related to an arrangement of the first image to be displayed by the image display device and the second image to be displayed by the other image display device;
deciding overall resolution as resolution for displaying the whole image based on the configuration information obtained to store the overall resolution to a resolution storage section;
notifying the image supply device with the overall resolution stored in the resolution storage section;
obtaining the image information from the image supply device notified with the overall resolution;
displaying the first image based on a part of the image information; and
outputting the image information to the other image display device configured to display the second image based on another part of the image information.

2. The method of controlling the image display device according to claim 1, wherein
a highest resolution value with which the image display device and the other image display device perform display is calculated based on the configuration information to decide the resolution value as the overall resolution.

3. The method of controlling the image display device according to claim 1, wherein
the image display device stores a resolution list including a plurality of resolution values,
a tentative resolution value as a highest resolution value with which the image display device and the other image display device can perform display is calculated based on the configuration information, and
a resolution value no higher than the tentative resolution value is extracted from the plurality of resolution values included in the resolution list to decide the extracted resolution value as the overall resolution.

4. The method of controlling the image display device according to claim 3, wherein
highest one of resolution values no higher than the tentative resolution value is extracted from the plurality of resolution values included in the resolution list to decide the extracted resolution value as the overall resolution.

5. The method of controlling the image display device according to claim 1, wherein
the image display device is a projector,
the first image and the second image are arranged so as to partially overlap each other, and
the configuration information includes information representing a width of an overlapping area where the first image and the second image overlap each other.

6. An image display device configured to display a whole image having a first image and a second image arranged based on image information supplied from an image supply device in cooperation with another image display device, comprising:
an acquisition section configured to obtain configuration information related to an arrangement of the first image to be displayed by the image display device and the second image to be displayed by the other image display device;
a decision section configured to decide overall resolution as resolution for displaying the whole image based on the configuration information obtained by the acquisition section;
a resolution storage section configured to store the overall resolution decided by the decision section;
a notification section configured to notify the image supply device with the overall resolution stored in the resolution storage section;
an input section to which the image information is input from the image supply device notified with the overall resolution;
a display section configured to display the first image based on a part of the image information; and
an output section configured to output the image information to the other image display device configured to display the second image based on another part of the image information.

7. An image display system comprising:
a first image display device configured to display a first image based on a part of image information supplied from an image supply device; and
a second image display device configured to display a second image based on another part of the image information, wherein
a whole image having the first image and the second image arranged is displayed, and
the first image display device includes
an acquisition section configured to obtain configuration information related to the arrangement of the first image and the second image,
a decision section configured to decide overall resolution as resolution for displaying the whole image based on the configuration information obtained by the acquisition section,
a resolution storage section configured to store the overall resolution decided by the decision section, a notification section configured to notify the image supply device with the overall resolution stored in the resolution storage section,
an input section to which the image information is input from the image supply device notified with the overall resolution,
a display section configured to display the first image based on the image information input to the input section, and
an output section configured to output the image information input to the input section to the second image display device.
